(19) United States
(12) Patent Application Publication
(10) Pub. No.: US 2026/0088943 A1
(43) Pub. Date: Mar. 26, 2026

(54) METHOD, DEVICE AND COMPUTER STORAGE MEDIUM OF COMMUNICATION

(71) Applicant: NEC Corporation, Tokyo (JP)

(72) Inventors: You LI, Beijing (CN); Gang WANG, Beijing (CN)

(73) Assignee: NEC Corporation, Tokyo (JP)

(21) Appl. No.: 19/114,145

(22) PCT Filed: Sep. 22, 2022
(86) PCT No.: PCT/CN2022/120641

§ 371 Date: Mar. 21, 2025

(51) Int. Cl. H04L 1/1867

(52) U.S. Cl. CPC H04L 1/189

(57) ABSTRACT

Example embodiments of the present disclosure relate to an effective mechanism for handing the scenario of discontinuous coverage. In this solution, a terminal device with a plurality of paths including a first path determines, at a first entity of the terminal device configured, a successful transmission associated with a packet data convergence protocol (PDCP) data packet data unit (PDU) on the first path, the first path being an indirect path, the first entity corresponding to the first path, a layer of the first entity being lower than a PDCP layer. Further, the terminal device performs one of the following transmitting, to a PDCP entity of the terminal device, a confirmation indication indicating the successful transmission; or disabling to transmit the confirmation indication to the PDCP entity.

### TECHNICAL FIELD

Embodiments of the present disclosure generally relate to the field of telecommunication, and in particular, to methods, devices and computer storage media for transmission management on multi-path.

### BACKGROUND

Recently, a technology of multi-path is proposed to be supported to enhance reliability and throughput. Specifically, a user equipment (UE) is allowed to communicate with the network via both a direct path and an indirect path, and the UE may switch among or utilize the multiple paths simultaneously. In addition, in case of the indirect path, the UE may connect to the network device via a layer-2 UE-to-network relay, or via another UE(where the UE-UE inter-connection is assumed to be ideal) .

Further, in order to enhance reliability, a technology of split bearer is also proposed, which means that the duplication(s) of data convergence protocol (PDCP) data packet data unit (PDU) will be stored in a lower entity for each path. Further, if the PDCP data PDU is successfully transmitted to the network device via a path of the multiple paths, the duplicate PDCP data PDU stored on the other path(s) should be discarded.

However, due to introducing the indirect path and especially for introducing the indirect path assumed to be ideal, the lower entity of the UE cannot indicate the successful transmission on an indirect path to the PDCP entity of the UE, which causes that the duplicate PDCP data PDU stored on the other path(s) cannot be discarded properly.

### SUMMARY

In general, embodiments of the present disclosure provide methods, devices and computer storage media for transmission management on multi-path.

In a first aspect, there is provided a method of communication. The method comprises: determining, at a first entity of a terminal device configured with a plurality of paths including a first path, a successful transmission associated with a PDCP data PDU on the first path, the first path being an indirect path, the first entity corresponding to the first path, a layer of the first entity being lower than a PDCP layer. The method further comprises performing one of the following: transmitting, to a PDCP entity of the terminal device, a confirmation indication indicating the successful transmission; or disabling to transmit the confirmation indication to the PDCP entity.

In a second aspect, there is provided a method of communication. The method comprises: determining, at a PDCP entity of a terminal device configured with a plurality of paths including a first path being an indirect path, a successful transmission associated with a PDCP data packet data unit (PDU) on the second path of the plurality of paths. The method further comprises transmitting, to a first entity corresponding to the first path, a discard indication indicating the indirect path to discard a duplication corresponding the PDCP data PDU, a layer of the first entity being lower than a PDCP layer.

In a third aspect, there is provided a terminal device. The terminal device includes a processing unit; and a memory coupled to the processing unit and storing instructions thereon, the instructions, when executed by the processing unit, causing the device to perform the method according to the first aspect.

In a fourth aspect, there is provided a terminal device. The terminal device includes a processing unit; and a memory coupled to the processing unit and storing instructions thereon, the instructions, when executed by the processing unit, causing the device to perform the method according to the first or second aspect.

In a fifth aspect, there is provided a computer readable medium having instructions stored thereon, the instructions, when executed on at least one processor, causing the at least one processor to carry out the method according to the first to any of the second aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A is a block diagrams of an example communication environment in which embodiments of the present disclosure can be implemented;

FIG. 1B is an example protocol structure of a direct path according to some embodiments of the present disclosure;

FIG. 1C is an example protocol structure of a standardized indirect path according to some embodiments of the present disclosure;

FIG. 1D is an example protocol structure of a non-standardized indirect path according to some embodiments of the present disclosure;

FIGS. 2A to 2C are example protocol structures of a terminal device according to some embodiments of the present disclosure, respectively;

FIGS. 3A and 3B are example interactions among the entities of a terminal device according to some embodiments of the present disclosure, respectively;

FIG. 4 is an example interaction among the entities of a terminal device according to some embodiments of the present disclosure;

FIG. 5 illustrates an example method of communication implemented at a terminal device in accordance with some embodiments of the present disclosure;

FIG. 6 illustrates another example method of communication implemented at a terminal device in accordance with some embodiments of the present disclosure; and FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further have ‘multicast/broadcast’ feature, to support public safety and mission critical, V2X applications, transparent IPv4/Ipv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As discussed above, technologies of multi-path and split bearer are proposed to enhance reliability and throughput. Further, the UE is allowed to communicate with the network via both a direct path and an indirect path, and the UE may switch among or utilize the multiple paths simultaneously.

In addition, in case of an indirect path, the UE may be connected to the network device via a layer-2 UE-to-network relay, or via another UE (where the UE-UE inter-connection is assumed to be ideal). However, due to introducing the indirect path and especially for introducing the indirect path assumed to be ideal, the lower entity cannot indicate the successful transmission on an indirect path to the PDCP entity of the UE, which causes that the duplicate PDCP data PDU stored on the other paths cannot be discarded properly.

Embodiments of the present disclosure provide a solution for transmission management on multi-path. In the present disclosure, if a successful transmission associated with a PDCP data PUD on an indirect path is determined at a lower entity (such as, a first entity with a layer lower than PDCP layer), the lower entity may be configured to transmit or disable to transmit a confirmation indication to the PDCP entity. In this way, the duplicate PDCP data PDU stored on the other path(s) may be discard or remained properly.

For ease of discussion, some terms used in the following description are listed as below:
A direct network connection: refers to one mode of network connection, where there is no relay terminal device/relay UE between a terminal device and the network device;
An indirect network connection: refers to one mode of network connection, where there is a relay terminal device/relay UE between a terminal device and the network device; also referred to as a relaying path sometimes;
An indirect path/link/connection: refer to any of the following: a path between a network device and a remote terminal device via a relay terminal device or multiple relay terminal devices, a path between a remote terminal device and a relay terminal device (i.e., a PC5 path/link/connection, or a sidelink path/link/connection, or a D2D path/link/connection, or, a non-standardized path/link/connection, or a non-3GPP path/link/connection), or a path/link/connection between a relay terminal device and a network device.
A non-standardized entity/path/link/connection: refers to an entity/path/link/connection which is not stipulated by the standard documents (such as, 3GPP specification) or is an ideal path/link/connection. Also may be referred to as non-3GPP entity/path/link/connection. Further, a non-standardized/path/link/connection also may be referred to as ideal/path/link/connection. Examples of non-standardized entity/path/link/connection, include but are not limited to, Wi-Fi entity/path/link/connection, bluetooth entity/path/link/connection, zigbee entity/path/link/connection and so on.
A standardized entity/path/link/connection: refers to an entity/path/link/connection which is stipulated by the standard documents (such as, 3GPP specification).
A first entity: refers to an entity at the terminal device. A layer of the first entity is lower than a PDCP layer. In some embodiments, the first entity may be a radio link control (RLC) entity. In some further embodiments, the first entity may be an SRAP entity. Alternatively, in some other embodiments, the first entity may be a non-standardized entity.

In the present discourse, terms of path, link, connection may be used interchangeably.

In the present discourse, terms of entity, layer, sublayer may be used interchangeably.

In the present discourse, descriptions of entity(ies) corresponding to a (direct/indirect) path, entity(ies) on a (direct/indirect) path, entity(ies) associated with a (direct/indirect) path may be used interchangeably.

Further, it is to be understood that same data may be represented in different data formats, such as, same data may be represented as, PDCP PDU, SRAP SDU, SRAP PDU, RLC SDU, RLC PDU, a non-standardized data unit/SDU/PDU, a non-3GPP data unit/SDU/PDU. In view of this, in some cases, terms of PDCP PDU, SRAP SDU, SRAP PDU, RLC SUC, RLC PDU, a non-standardized data unit/SDU/PDU, a non-3GPP data unit/SDU/PDU, may be used interchangeably.

According to some embodiments of the present discourse, the remote terminal device is configured with a plurality of paths including at least a first path and a second path. That is, the remote terminal device may be configured with a first path, a second path and optionally one or more other paths. Further, in some embodiments, the first path is an indirect path, and any of the second path and the one or more other paths may be either a direct path or an indirect path. In the following example embodiments, the first path and the second path are used as example paths. It is to be understood that the embodiments described with regard to the first path and the second path are suitable for any other paths.

Principles and implementations of the present disclosure will be described in detail below with reference to the figures.

### EXAMPLE OF COMMUNICATION NETWORK

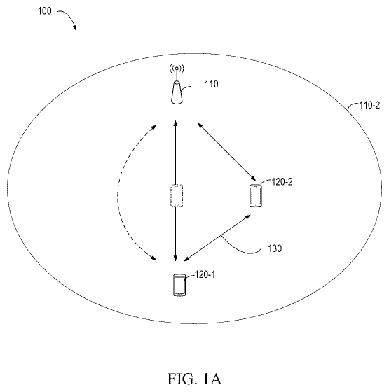

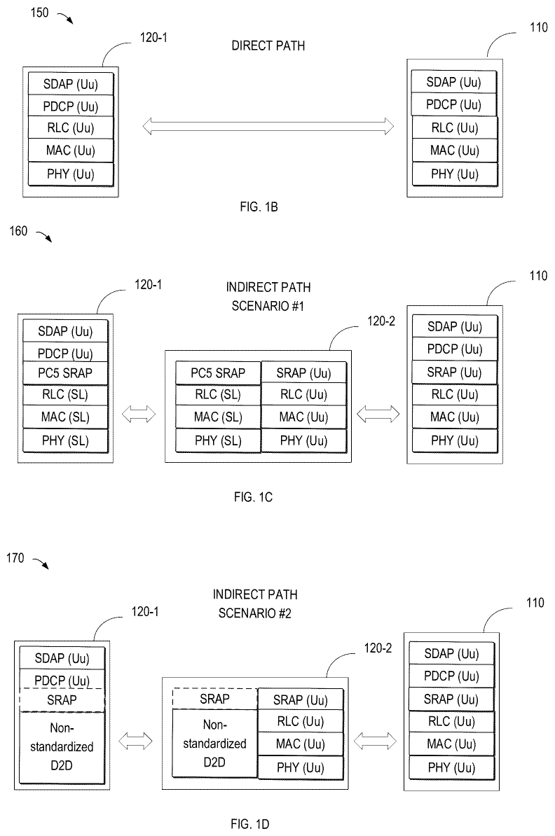

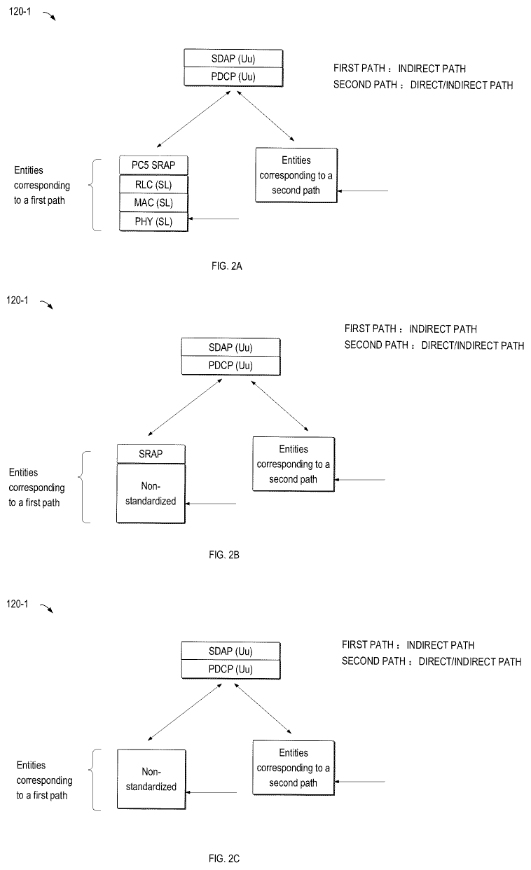

FIG. 1A shows an example communication environment 100 in which example embodiments of the present disclosure can be implemented. The communication environment 100 comprises a plurality of terminal devices and a network device. As shown in the FIG. 1A, the communication environment 100 comprises a network device 110, which providing a serving area, called as a cell 110-2.

Further, the communication environment 100 also comprises terminal devices 120-1 and 120-2. For purpose of discussion, the terminal devices 120-1 and 120-2 are collectively referred to as terminal device 120.

Further, the terminal device 120-1 may communicate with the network device 110 via a plurality of paths (also referred to as multi-path), where each of the plurality of paths may be either a direct path or an indirect path. As shown in FIG. 1A, the terminal device 120-1 (also referred to as remote UE or remote terminal device) may communicate with the network device 110 via the terminal device 120-2 (also referred to as relay UE or relay terminal device), while the terminal device 120-1 may communicate with the network device 110 directly.

In some embodiments, as for the terminal device 120-1, the following entities are configured for a direct path: a PDCP entity, a radio link control (RLC) entity, and a media access control (MAC) entity.

In some embodiments, as for the terminal device 120-1, the following entities are configured for a standardized indirect path: a PDCP entity, a sidelink relay adaptation protocol (SRAP) entity, an RLC entity, and a MAC entity.

In some embodiments, as for the terminal device 120-1, the following entities are configured for a standardized indirect path: a PDCP entity, an SRAP entity, an RLC entity, and a MAC entity.

In some embodiments, as for the terminal device 120-1, an SRAP entity and a non-standardized entity (also be referred to non-3GPP device-to-device (D2D) entity) may be configured for a non-standardized indirect path. Alternatively, in some embodiments, the SRAP entity may be absent for the non-standardized indirect path.

In summary, the terminal device 120-1 may communicate with the network device 110 via any of the following paths:
A direct path, where the terminal device 120-1 is connected to the network device 110 directly. An example protocol structure 150 of the direct path is illustrated in FIG. 1B.
A standardized indirect path, where the terminal device 120-1 is connected to the network device 110 via the terminal device 120-2, and the path between the terminal device 120-1 and the terminal device 120-2 is PC5/sidelink(SL) path. An example protocol structure 160 of the standardized indirect path is illustrated in FIG. 1C.
A non-standardized indirect path, where the terminal device 120-1 is connected to the network device 110 via the terminal device 120-2, and the path between the terminal device 120-1 and the terminal device 120-2 is non-standardized path. An example protocol structure 170 of the non-standardized indirect path is illustrated in FIG. 1D, where the SRAP entity is optional.

In some embodiments, the terminal device 120-1 may be connected to the network device 110 by using one direct path and one indirect path via layer-2 UE-to-network relay, referred to as scenario #1 sometimes. Alternately, in some embodiments, the terminal device 120-1 may be connected to the network device 110 by using one direct path and one indirect path via the terminal device 120-2 (where the UE-UE inter-connection is assumed to be ideal, referred to as scenario #2 sometimes).

In some embodiments, it is expected to benefit from multi-path in the following aspects:
Relay and direct multi-path operation (including both scenarios #1 and #2) can provide efficient path switching between direct path and indirect path;
The remote terminal device 120-1 in multi-path operation can provide enhanced user data throughput and reliability compared to a single link; and
the network device 110 can offload the direct connection of the remote terminal device 120-1 in congestion to indirect path via the terminal device 120-2 (for example, at different intra/inter-frequency cells).

In some embodiments, the terminal device 120-1 supports direct bearer (i.e., bearer mapped to direct path on Uu), indirect bearer (i.e., bearer mapped to indirect path via relay UE), and multi-path (MP) split bearer (i.e., bearer mapped to both paths, based on the existing split bearer framework).

In some embodiments, the relation between the terminal device 120-1 and the terminal device 120-2 involved in a non-standardized indirect path is pre-configured or static. As one specific example, the mapping between the terminal device 120-1 and the terminal device 120-2 is a 1:1 mapping.

In some embodiments, a procedure of duplicate PDU discard may be triggered at a PDCP entity of terminal device 120-1. In one specific embodiment, the terminal device 120-1 is configured with two acknowledged mode (AM) RLC entities, and the PDCP entity of the terminal device 120-1 is configured with pdcp-Duplication. In this specific embodiment, when receiving a positive acknowledgement for an RLC SDU with SN=x, the transmitting side of an AM RLC entity shall: send an indication to the upper layers of successful delivery of the RLC SDU; and further set TX_Next_Ack equal to the SN of the RLC SDU with the smallest SN, whose SN falls within the range TX_Next_Ack<=SN<=TX_Next and for which a positive acknowledgment has not been received yet.

Further, in this specific embodiment, if the successful delivery of a PDCP Data PDU is confirmed by one of the associated AM RLC entities, the transmitting PDCP entity may indicate to the other AM RLC entities to discard the duplicate PDCP Data PDU.

As for the RLC entity, when indicated from upper layer/entity (i.e., PDCP layer/entity) to discard a particular RLC service data unit (SDU) (for example, a RLC SDU corresponding to an PDCP Data PDU), the transmitting side of an AM RLC entity or the transmitting unacknowledged mode (UM) RLC entity shall discard the indicated RLC SDU, if neither the RLC SDU nor a segment thereof has been submitted to the lower layers. The transmitting side of an AM RLC entity shall not introduce an RLC SN gap when discarding an RLC SDU.

It should be appreciated that the numbers and types of devices/entities in FIGS. 1A to 1D are given for the purpose of illustration without suggesting any limitations to the present disclosure. The communication environment 100 may include any suitable number of network devices and/or terminal devices adapted for implementing implementations of the present disclosure. Further, the communication environment 100 may include any other devices than the network devices and the terminal devices, such as a core network element, but they are omitted here so as to avoid obscuring the present invention.

In some embodiments, the terminal device 120 and the network device 110 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Example Processed For Transmission Management on Multi-Path

It should be understood that although feature(s)/operation(s) are discussed in specific example embodiments separately, unless clearly indicated to the contrary, these feature(s)/operation(s) described in different example embodiments may be used in any suitable combination.

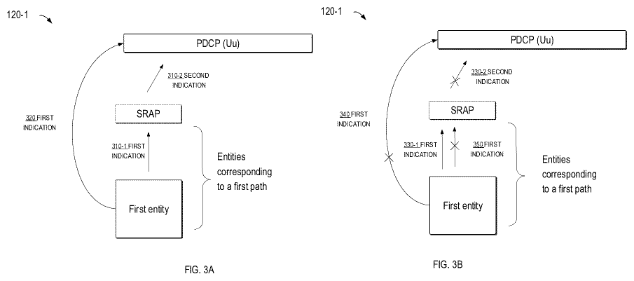

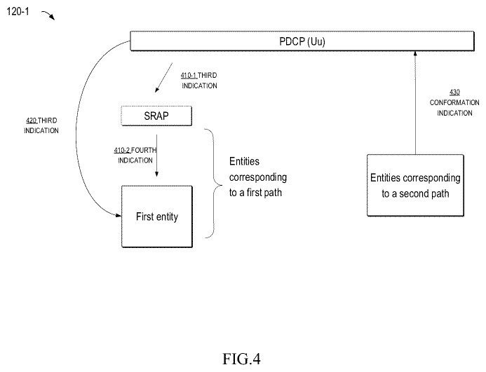

Principle and implementations of the present disclosure will be described in detail below with reference to FIGS. 2A to 4. For the purpose of discussion, FIGS. 2A to 4 will be described with reference to FIGS. 1A to 1D.

Further, in the following, a specific example embodiment is referred merely for better understanding. In this specific example embodiment, the terminal device 120-1 is configured with a plurality of paths including a first path and a second path, where the first path may an indirect path and the second path may be either a direct or an indirect path. In this specific example embodiment, entities of the first path and entities of the second path are associated with one PDCP entity (for example, a split bearer is configured). Further, duplicate PDCP PDUs may be transmitted via more than one path (such as, both the first and second paths).

Reference is made to FIG. 2A, which illustrates an example protocol structure of the terminal device 120-1 according to some embodiments of the present disclosure. In the specific embodiments of FIG. 2A, the first path of the terminal device 120-1 is a standardized indirect path. For example, the terminal device 120-1 is connected to the terminal device 120-2 via a PC5 interface or a sidelink connection. Additionally, in the specific embodiments of FIG. 2A, the following entities are configured for the first path: an RLC entity, and a MAC entity.

FIGS. 2B and 2C illustrate other example protocol structures of the terminal device 120-2 according to some embodiments of the present disclosure, where the first path is a non-standardized indirect path. In the specific example embodiment of FIG. 2B, the following entities are configured for the first path: an SRAP entity and a non-standardized entity. In the specific example embodiment of FIG. 2C, a non-standardized entity is configured for the first path.

In the following, example processes about how to handle the successful transmission associated with a PDCP PDU(for example, PDCP data PDU) on an indirect path and how to handle the discard of duplicate PDCP data PDU will be discussed in detail.

### Handling Successful Transmission on an Indirect Path

In some embodiments, the terminal device 120-1 is configured a first entity corresponding to the first path (i.e., an indirect path), where a layer of the first entity is lower than a PDCP layer. As discussed above, the terminal device 120-1 may be configured with different protocol structures (as illustrated in FIGS. 2A to 2C) for an indirect path. In view of this, the first entity may be different entities according to different protocol structures. One example of the first entity is RLC entity (as illustrated in FIG. 2A). Another example of the first entity is a non-standardized entity (as illustrated in FIGS. 2B and 2C).

According to the some embodiments of the present discourse, an indication indicating the successful transmission (also referred to as “confirmation indication” in the following text) will be transmitted to the PDCP entity. Based on the received confirmation indication, the PDCP entity may trigger the discard of duplicate PDCP data PDU properly. In this way, the unnecessary resource may be released timely.

In some embodiments, the first entity of the terminal device 120-1 determines a successful transmission associated with a PDCP data PDU on the first path. For example, the first entity receives a positive acknowledgement from the terminal device 120-2.

In some embodiments, the successful transmission may be allowed to be informed to the PDCP entity. As a result, the first entity may transmit a confirmation indication indicating the successful transmission to the PDCP entity.

In some embodiments, the confirmation indication may indicate some details about the successful transmission, such that the PDCP entity may well understand the transmission status of the related PDCP data PDU.

In some embodiments, the confirmation indication may comprise a 1-bit indication that indicates the successful transmission. Alternatively, or in addition, in some embodiments, the confirmation indication may indicate a radio bearer (RB) identity, such as, an identity of signalling radio bearer (SRB), or an identity of data radio bearer (DRB). Alternatively, or in addition, in some embodiments, the confirmation indication may indicate an RB type, such as, SRB or DRB.

Alternatively, or in addition, in some embodiments, the confirmation indication may indicate a sequence number corresponding to the PDCP data PDU. It is to be understood that the sequence number corresponding to the PDCP data PDU may be any suitable sequence number of data unit, such as, a sequence number of non-standardized data unit/PDU/SDU, a sequence number of RLC PDU/SDU, a sequence number of the PDCP PDU/SDU or a sequence number of SRAP PDU/SDU and so on. The present disclosure is not limited in this regard.

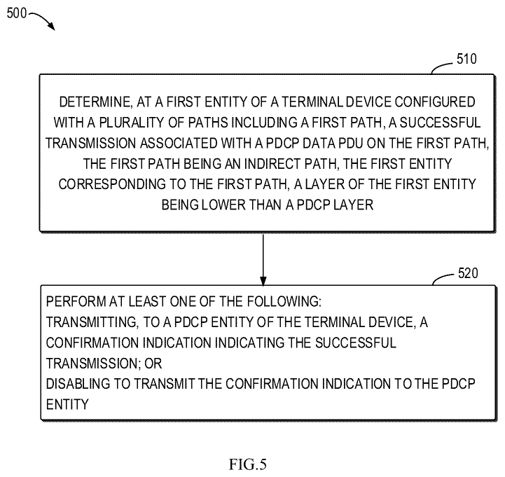

The detailed transmission procedures of the confirmation indication will be discussed with reference to FIG. 3A.

As illustrated in FIG. 3A, in some embodiments, the first entity transmits 310-1 a first indication indicating the successful transmission to the SRAP entity corresponding to the first path. In one specific example embodiment, the first path is a standardized indirect path, and an SRAP entity, an RLC entity (such as, a PC5 AM RLC entity), a MAC entity and a PHY entity are configured for the first path. In this event, the RLC entity transmits the first indication to the SRAP entity. In another specific example embodiment, the first path is a non-standardized indirect, and an SRAP entity and a non-standardized entity are configured for the first path. In this event, the non-standardized entity may transmit the first indication to the SRAP entity. Next, in some embodiment, the SRAP entity may transmit 310-2 a second indication corresponding to the first indication to the PDCP entity. Alternatively, in some embodiment, the SRAP entity may merely forward a second indication corresponding to the first indication to the PDCP entity.

It is to be understood that the second indication and the first indication are corresponding to a same PDCP data PDU. At the same time, the second indication and the first indication may be represented in different formats, such as, the first indication indicates a successful transmission of a RLC SDU, while the second indication indicates a successful transmission of an SRAP SDU.

Alternatively, in some embodiment, the transmission of the confirmation indication may be performed independently from the SRAP entity. Specifically, as illustrated in FIG. 3A, in some embodiments, the first entity may transmit 320 first indication indicating the successful transmission to the PDCP entity directly.

In one specific example embodiment, the first path is a standardized indirect, and an SRAP entity, an RLC entity, a MAC entity and a PHY entity are configured for the first path. In this event, the RLC entity transmits the first indication to PDCP entity directly, even if the SRAP entity is configured.

In another specific example embodiment, the first path is a non-standardized indirect, and an SRAP entity and a non-standardized entity are configured for the first path. In this event, the non-standardized entity may transmit the first indication to PDCP entity directly, even if the SRAP entity is configured.

In a further specific example embodiment, the first path is a non-standardized indirect, and a non-standardized entity is configured for the first path. In this event, the non-standardized entity may transmit the first indication to PDCP entity directly.

With this confirmation indication, the PDCP entity may trigger to discard the duplicate PDCP data PDU on the other path(s) (i.e., a second path). In this way, a PDCP entity may be aware of the successful delivery of a PDCP data PDU via an indirect path and trigger to discard the duplicate PDCP data PDU timely.

As discussed above, the indirect path refers to a scenario that the terminal device 120-1 communicates with the network device 110 via the terminal device 120-2. It is preferred that the duplicate PDCP data PDU may be discarded only if the PDCP data PDU has been successfully transmitted to the network device 110. However, a confirmation from the terminal device 120-2 only means a successful transmission from the terminal device 120-1 to the terminal device 120-2, which does not equate that the PDCP data PDU has been successfully transmitted to the network device 110.

In view of this, the successful transmission associated with PDCP data PDU from the terminal device 120-2 should not be indicated to the PDCP entity. Accordingly, in some embodiments, the first entity of the terminal device 120-1 determines a successful transmission associated with a PDCP data PDU on the first path. For example, the first entity receives a positive acknowledgement from the terminal device 120-2. However, in some embodiments, transmission of the confirmation indication is disabled.

The detailed procedures of disabling the transmission of confirmation indication will be discussed with reference to FIG. 3B.

As illustrated in FIG. 3B, in some embodiments, the first entity disables 350 to transmit the first indication indicating the successful transmission to the SRAP entity corresponding to the first path. In one specific example embodiment, the first path is a standardized indirect path, and an SRAP entity, an RLC entity (such as, a PC5 AM RLC entity), a MAC entity and a PHY entity are configured for the first path. In this event, the RLC entity disables to transmit the first indication to the SRAP entity. In another specific example embodiment, the first path is a non-standardized indirect, and an SRAP entity and a non-standardized entity are configured for the first path. In this event, the non-standardized entity disables to transmit the first indication to the SRAP entity.

Alternatively, in some embodiments, the first entity disables 340 to transmits the first indication indicating the successful transmission to the PDCP entity directly. In one specific example embodiment, the first path is a standardized indirect path, and an SRAP entity, an RLC entity (such as, a PC5 AM RLC entity), a MAC entity and a PHY entity are configured for the first path. In this event, the RLC entity disables to transmit the first indication to the PDCP entity directly. In another specific example embodiment, the first path is a non-standardized indirect path, and an SRAP entity and a non-standardized entity are configured for the first path. In this event, the non-standardized entity disables to transmit the first indication to the PDCP entity directly.

Alternatively, in some embodiments, the first entity may transmit 330-1 the first indication indicating the successful transmission to the SRAP entity. However, the transmission of the second indication corresponding to the first indication to the PDCP entity is disabled 330-2. In one specific example embodiment, the first path is a standardized indirect path, and an SRAP entity, an RLC entity (such as, a PC5 AM RLC entity), and a MAC entity are configured for the first path. In this event, the RLC entity transmit the first indication to the SRAP entity, and the SRAP entity disables to transmit the second indication to the PDCP entity. In another specific example embodiment, the first path is a non-standardized indirect, and an SRAP entity and a non-standardized entity are configured for the first path. In this event, the non-standardized entity transmits the first indication to the SRAP entity, and the SRAP entity disables to transmit the second indication to the PDCP entity.

In addition to disabling the transmission of the confirmation indication, the PDCP entity also may disable to indicate the other path(s) to discard a duplication corresponding the PDCP data PDU, such that an improper discard procedure is avoided. Specifically, after receiving the confirmation indication, the PDCP entity disables to indicate an entity corresponding to the other path to discard a duplication corresponding the PDCP data PDU. As the other path may be any of a direct path, a non-standardized indirect path or a standardized indirect path, the entity corresponding to the other path may be a RLC entity, an SRAP entity or a non-standardized entity accordingly.

In one specific example embodiment, the other path is a direct path, and an RLC entity (such as, a PC5 AM RLC entity), a MAC entity and a PHY entity are configured for the other path. In this event, after receiving the confirmation indication, the PDCP entity disables to indicate the RLC entity corresponding to the other path to discard a duplication corresponding the PDCP data PDU.

In another specific example embodiment, the other path is a standardized indirect, and an SRAP entity, an RLC entity (such as, a PC5 AM RLC entity), a MAC entity and a PHY entity are configured for the other path. In some embodiments, after receiving the confirmation indication, the PDCP entity disables to indicate the RLC entity corresponding to the other path to discard a duplication corresponding the PDCP data PDU, even if the SRAP entity is configured. Alternatively, or additionally, the PDCP entity disables to indicate the SRAP entity corresponding to the other path to discard a duplication corresponding the PDCP data PDU.

In a further specific example embodiment, the other path is a non-standardized indirect, and an SRAP entity and a non-standardized entity are configured for the other path. In this event, the PDCP entity disables to indicate the SRAP entity corresponding to the other path to discard a duplication corresponding the PDCP data PDU. Alternatively, the other path is a non-standardized indirect path, and a non-standardized entity is configured for the other path. In this event, the PDCP entity disables to indicate the non-standardized entity corresponding to the other path to discard a duplication corresponding the PDCP data PDU.

In this way, the improper discarding PDCP data PDU is avoided.

### Pdcp Data Pdu Discard on an Indirect Path

Generally speaking, as for multi-path, in case that the PDCP data PDU has been successfully transmitted on one path (either a direct path or an indirect path), the duplication corresponding the PDCP data PDU should be discarded. In the following, example processes for discarding the PDCP data PDU on an indirect path will be discussed. For better understanding, the detailed discarding procedure will be discussed with reference to FIG. 4.

In some embodiments, a PDCP entity of the terminal device 120-1determines a successful transmission associated with a PDCP data PDU on either a direct path or an indirect path.

How to determine the successful transmission associated with a PDCP data PDU on an indirect path has been discussed in detail previously. Merely for brevity, some contents are omitted here. As for direct path, an RLC entity (such as, an AM RLC entity) of the terminal device 120-1 may receive a positive acknowledgement from the network device 110, and the RLC entity may indicate the successful transmission to the PDCP entity.

As illustrated in FIG. 4, in some embodiments, the PDCP entity of the terminal device 120-1 determines a successful transmission associated with a PDCP data PDU on the second path by receiving 430 a confirmation indication from the first entity corresponding to the second path.

Upon determining the successful transmission, the PDCP entity may trigger the procedure of PDCP data PDU discard. In some embodiments, the PDCP entity transmits a discard indication indicating the first path to discard a duplication corresponding the PDCP data PDU.

In some embodiments, the discard indication may indicate some details about the successful transmission, such that the first entity may well understand the transmission status of the related PDCP data PDU.

In some embodiments, the discard indication may comprise a 1-bit indication that indicating the successful transmission. Alternatively, or in addition, in some embodiments, the discard indication may indicate an RB identity, such as, an identity of SRB, or an identity of DRB. Alternatively, or in addition, in some embodiments, the confirmation indication indicates an RB type, such as, SRB or DRB. Alternatively, or in addition, in some embodiments, the discard indication indicates a sequence number corresponding to the PDCP data PDU.

The detailed transmission procedures of the discard indication will be discussed with reference to FIG. 4.

As illustrated in FIG. 4, in some embodiments, the PDCP entity transmits 410-1 a third indication indicating the first path to discard the duplication corresponding the PDCP data PDU to an SRAP entity corresponding to the first path.

In one specific example embodiment, the first path is a standardized indirect, and an SRAP entity, an RLC entity (such as, a PC5 AM RLC entity), a MAC entity and a PHY entity are configured for the first path. In another specific example embodiment, the first path is a non-standardized indirect, and an SRAP entity and a non-standardized entity are configured for the first path. In these specific example embodiments, the PDCP entity transmits the third indication to SRAP entity of the indirect path.

In some embodiments, after receiving the third indication, the SRAP entity determines whether an SRAP SDU corresponding to the PDCP data PDU has been submitted to the first entity. If the SRAP SDU has been submitted to the first entity as an SRAP PDU, the SRAP entity transmits 410-2 a fourth indication corresponding to the third indication to the first entity. Else, the SRAP entity discards the SRAP SDU at the SRAP entity. In one specific example embodiment, the first path is a standardized indirect path, the SRAP entity may transmit the fourth indication to an RLC entity corresponding to the first path. In one specific example embodiment, the first path is a non-standardized indirect path, the SRAP entity may transmits the fourth indication to a non-standardized entity corresponding to the first path.

In some embodiments, when indicated by an upper layer/entity (i.e., PDCP layer/entity) to discard a particular SRAP SDU, the transmitting part of an SRAP entity shall discard the indicated SRAP SDU, if the SRAP SDU has not been submitted to the lower layers. Alternatively, if the SRAP SDU has been submitted to the lower layers, the SRAP entity may indicate to the related AM RLC entity to discard the particular RLC SDU(SRAP PDU). Further, the RLC SDU and SRAP SDU include the same PDCP Data PDU.

In this way, even if an SRAP layer is introduced for indirect path, the PDCP also may trigger to discard the duplicate PDCP data PDU properly.

Alternatively, the PDCP entity also may indicate the first entity to discard the related PDCP data PDU directly, regardless of whether the terminal device 120-1 is configured with an SRAP entity. Specifically, as illustrated in FIG. 4, in some embodiments, the PDCP entity may transmit 420 the third indication indicating the first path to discard a duplication corresponding the PDCP data PDU directly.

In one specific example embodiment, the first path is a standardized indirect path, and an SRAP entity, an RLC entity, a MAC entity and a PHY entity are configured for the first path. In this event, the PDCP entity transmits the third indication to RLC entity directly, even if the SRAP entity is configured.

In another specific example embodiment, the first path is a non-standardized indirect path, and an SRAP entity and a non-standardized entity are configured for the first path. In this event, the PDCP may transmit the third indication to non-standardized entity directly, even if the SRAP entity is configured.

In a further specific example embodiment, the first path is a non-standardized indirect path, and a non-standardized entity is configured for the first path. In this event, the PDCP may transmit the third indication to non-standardized entity directly.

In this way, the unnecessary resource used for storing the duplication of the PDCP data PDU which has been successfully transmitted may be released timely.

### Example of Methods

FIG. 5 illustrates a flowchart of an example method 500 in accordance with some embodiments of the present disclosure. For example, the method 500 can be implemented at the remote terminal device 120-1 as shown in FIG. 1A.

At block 510, the terminal device 120-1 configured with a plurality of paths including a first path determines, at a first entity of the terminal device 120-1, a successful transmission associated with a PDCP PDU on the first path, where the first path is an indirect path, the first entity corresponds to the first path, a layer of the first entity is lower than a PDCP layer.

At block 520, the terminal device 120-1 performs one of the following: transmitting, to a PDCP entity of the terminal device 120-1, a confirmation indication indicating the successful transmission; or disabling to transmit the confirmation indication to the PDCP entity.

In some embodiments, the confirmation indication indicates at least one of the following: an RB identity, an RB type, a sequence number corresponding to the PDCP data PDU, or a successful transmission of the PDCP data PDU.

In some embodiments, the first entity is an RLC entity, or a non-standardized entity.

In some embodiments, the terminal device 120-1 transmits, at the first entity, a first indication indicating the successful transmission to an SRAP entity corresponding to the first path, and further transmits, at the SRAP entity, a second indication corresponding to the first indication to the PDCP entity.

In some embodiments, the terminal device 120-1 transmits, at the first entity, a first indication indicating the successful transmission to the PDCP entity directly.

In some embodiments, the terminal device 120-1 disables, at the first entity, the transmission of a first indication indicating the successful transmission to the PDCP entity directly or to an SRAP entity corresponding to the first path.

In some embodiments, the terminal device 120-1 transmits, at the first entity, a first indication indicating the successful transmission to an SRAP entity corresponding to the first path and further disables, at the SRAP entity, a transmission of a second indication corresponding to the first indication to the PDCP entity.

In some embodiments, after receiving the confirmation indication, the terminal device 120-1 disables, at the PDCP entity, to indicate an entity corresponding to a second path of the plurality of paths to discard a duplication corresponding the PDCP data PDU, the entity corresponding to the second path being one of the following: an RLC entity, an SRAP entity, or a non-standardized entity.

In some embodiments, the second path is either a direct path or a further indirect path.

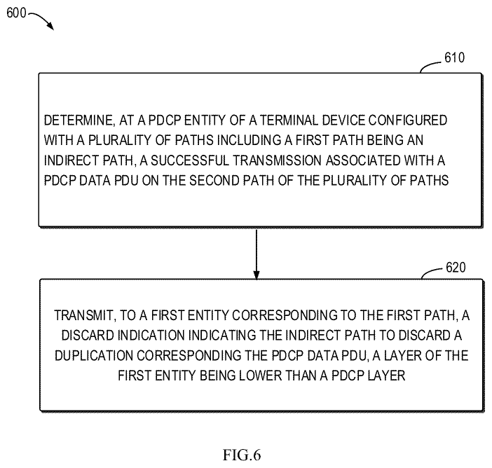

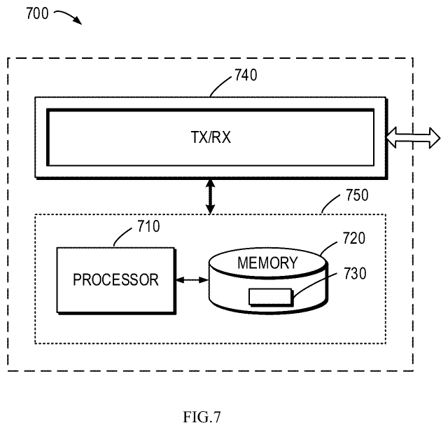

FIG. 6 illustrates a flowchart of an example method 600 in accordance with some embodiments of the present disclosure. For example, the method 600 can be implemented at the remote terminal device 120-1 as shown in FIG. 1A.

At block 610, the terminal device 120-1 determines, at a PDCP entity of the terminal device 120-1 configured with a plurality of paths including a first path being an indirect path, a successful transmission associated with a PDCP PDU on the second path of the plurality of paths.

At block 620, the terminal device 120-1 transmits, to a first entity corresponding to the first path, a discard indication indicating the first path to discard a duplication corresponding the PDCP data PDU, a layer of the first entity being lower than a PDCP layer.

In some embodiments, the second path is either a direct path or a further indirect path.

In some embodiments, the discard indication indicates at least one of the following: an RB identity, an RB type, a number sequence corresponding to the PDCP data PDU, or a successful transmission of the PDCP data PDU.

In some embodiments, the first entity is an RLC entity, or a non-standardized entity.

In some embodiments, the terminal device 120-1 transmits, at the PDCP entity, a third indication to an SRAP entity corresponding to the first path, the third indication indicating the first path to discard the duplication corresponding the PDCP data PDU.

In some embodiments, after receiving the third indication, the terminal device 120-1 determines, at the SRAP entity, whether an SRAP SDU corresponding to the PDCP data PDU has been submitted to the first entity. Further, in accordance with a determination that the SRAP SDU has been submitted to the first entity as an SRAP PDU, the terminal device 120-1 transmits, at the SRAP entity, a fourth indication corresponding to the third indication to the first entity; and in accordance with a determination that the SRAP SDU has not been submitted to the first entity, the terminal device 120-1 120-1 discards the SRAP SDU at the SRAP entity.

In some embodiments, the terminal device 120-1 transmits, at the PDCP entity, a third indication to the first entity directly.

### Example of Apparatuses and Devices

FIG. 7 is a simplified block diagram of a device 700 that is suitable for implementing embodiments of the present disclosure. The device 700 can be considered as a further example implementation of the terminal device 120 as shown in FIG. 1A. Accordingly, the device 700 can be implemented at or as at least a part of the terminal device 120.

As shown, the device 700 includes a processor 710, a memory 720 coupled to the processor 710, a suitable transmitter (TX)/receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1A to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a terminal device 120-1 configured with a plurality of paths including a first path comprises a circuitry configured to: determine, at a first entity of the terminal device 120-1, a successful transmission associated with a PDCP PDU on the first path, where the first path is an indirect path, the first entity corresponds to the first path, a layer of the first entity is lower than a PDCP layer; and perform one of the following: transmitting, to a PDCP entity of the terminal device 120-1, a confirmation indication indicating the successful transmission; or disabling to transmit the confirmation indication to the PDCP entity.

In some embodiments, the confirmation indication indicates at least one of the following: an RB identity, an RB type, a sequence number corresponding to the PDCP data PDU, or a successful transmission of the PDCP data PDU.

In some embodiments, the first entity is an RLC entity, or a non-standardized entity.

In some embodiments, the circuitry is further configured to transmit, at the first entity, a first indication indicating the successful transmission to an SRAP entity corresponding to the first path, and further transmits, at the SRAP entity, a second indication corresponding to the first indication to the PDCP entity.

In some embodiments, the circuitry is further configured to transmit, at the first entity, a first indication indicating the successful transmission to the PDCP entity directly.

In some embodiments, the circuitry is further configured to disable, at the first entity, the transmission of a first indication indicating the successful transmission to the PDCP entity directly or to an SRAP entity corresponding to the first path.

In some embodiments, the circuitry is further configured to transmit, at the first entity, a first indication indicating the successful transmission to an SRAP entity corresponding to the first path and further disable, at the SRAP entity, a transmission of a second indication corresponding to the first indication to the PDCP entity.

In some embodiments, the circuitry is further configured to: after receiving the confirmation indication, disable, at the PDCP entity, to indicate an entity corresponding to a second path of the plurality of paths to discard a duplication corresponding the PDCP data PDU, the entity corresponding to the second path being one of the following: an RLC entity, an SRAP entity, or a non-standardized entity.

In some embodiments, the second path is either a direct path or a further indirect path.

In some embodiments, a terminal device 120-1 configured with a plurality of paths including a first path comprises a circuitry configured to: determines, at a PDCP entity of the terminal device 120-1, a successful transmission associated with a PDCP PDU on the second path of the plurality of paths, where the first path in an indirect path; and transmit, to a first entity corresponding to the first path, a discard indication indicating the first path to discard a duplication corresponding the PDCP data PDU, a layer of the first entity being lower than a PDCP layer.

In some embodiments, the second path is either a direct path or a further indirect path.

In some embodiments, the discard indication indicates at least one of the following: an RB identity, an RB type, a number sequence corresponding to the PDCP data PDU, or a successful transmission of the PDCP data PDU.

In some embodiments, the first entity is an RLC entity, or a non-standardized entity.

In some embodiments, the circuitry is further configured to transmit, at the PDCP entity, a third indication to an SRAP entity corresponding to the first path, the third indication indicating the first path to discard the duplication corresponding the PDCP data PDU.

In some embodiments, the circuitry is further configured to: after receiving the third indication, the terminal device 120-1, determine, at the SRAP entity, whether an SRAP SDU corresponding to the PDCP data PDU has been submitted to the first entity. Further, the circuitry is further configured to: in accordance with a determination that the SRAP SDU has been submitted to the first entity as an SRAP PDU, transmit, at the SRAP entity, a fourth indication corresponding to the third indication to the first entity; and in accordance with a determination that the SRAP SDU has not been submitted to the first entity, discard the SRAP SDU at the SRAP entity.

In some embodiments, the circuitry is further configured to: transmit, at the PDCP entity, a third indication to the first entity directly.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication comprises: determining, at a first entity of a terminal device configured with a plurality of paths including a first path, a successful transmission associated with a packet data convergence protocol (PDCP) data packet data unit (PDU) on the first path, the first path being an indirect path, the first entity corresponding to the first path, a layer of the first entity being lower than a PDCP layer; and performing one of the following: transmitting, to a PDCP entity of the terminal device, a confirmation indication indicating the successful transmission; or disabling to transmit the confirmation indication to the PDCP entity.

In some embodiments, the confirmation indication indicates at least one of the following: a radio bearer (RB) identity, an RB type, a sequence number corresponding to the PDCP data PDU, or a successful transmission of the PDCP data PDU.

In some embodiments, the first entity is a radio link control (RLC) entity, or a non-standardized entity.

In some embodiments, transmitting the confirmation indication to the PDCP entity comprises: transmitting, at the first entity, a first indication indicating the successful transmission to a sidelink relay adaptation protocol (SRAP) entity corresponding to the first path; and transmitting, at the SRAP entity, a second indication corresponding to the first indication to the PDCP entity.

In some embodiments, transmitting the confirmation indication to the PDCP entity comprises: transmitting, at the first entity, a first indication indicating the successful transmission to the PDCP entity directly.

In some embodiments, disabling to transmit the confirmation indication to the PDCP entity comprises: disabling, at the first entity, the transmission of a first indication indicating the successful transmission to the PDCP entity directly or to a sidelink relay adaptation protocol (SRAP) entity corresponding to the first path.

In some embodiments, disabling to transmit the confirmation indication to the PDCP entity comprises: transmitting, at the first entity, a first indication indicating the successful transmission to a sidelink relay adaptation protocol (SRAP) entity corresponding to the first path; and disabling, at the SRAP entity, a transmission of a second indication corresponding to the first indication to the PDCP entity.

In some embodiments, the method further comprises: after receiving the confirmation indication, disabling, at the PDCP entity, to indicate an entity corresponding to a second path of the plurality of paths to discard a duplication corresponding the PDCP data PDU, the entity corresponding to the second path being one of the following: a radio link control (RLC) entity, a sidelink relay adaptation protocol (SRAP) entity, or a non-standardized entity.

In some embodiments, the second path is either a direct path or a further indirect path.

In another solution, a method of communication comprises: determining, at a packet data convergence protocol (PDCP) entity of a terminal device configured with a plurality of paths including a first path being an indirect path, a successful transmission associated with a PDCP data packet data unit (PDU) on the second path of the plurality of paths; and transmitting, to a first entity corresponding to the first path, a discard indication indicating the first path to discard a duplication corresponding the PDCP data PDU, a layer of the first entity being lower than a PDCP layer.

In some embodiments, the second path is either a direct path or a further indirect path.

In some embodiments, the discard indication indicates at least one of the following: a radio bearer (RB) identity, an RB type, a number sequence corresponding to the PDCP data PDU, or a successful transmission of the PDCP data PDU.

In some embodiments, the first entity is a radio link control (RLC) entity, or a non-standardized entity.

In some embodiments, transmitting the discard indication comprises: transmitting, at the PDCP entity, a third indication to a sidelink relay adaptation protocol (SRAP) entity corresponding to the first path, the third indication indicating the first path to discard the duplication corresponding the PDCP data PDU.

In some embodiments, the method further comprises: after receiving the third indication, determining, at the SRAP entity, whether an SRAP SDU corresponding to the PDCP data PDU has been submitted to the first entity; in accordance with a determination that the SRAP SDU has been submitted to the first entity as an SRAP PDU, transmitting, at the SRAP entity, a fourth indication corresponding to the third indication to the first entity; and in accordance with a determination that the SRAP SDU has not been submitted to the first entity, discarding the SRAP SDU at the SRAP entity.

In some embodiments, transmitting the discard indication comprises: transmitting, at the PDCP entity, a third indication to the first entity directly.

In another solution, a device of communication comprises: a processor configured to cause the device to perform any of the methods above.

In a further solution, a computer readable medium has instructions stored thereon, the instructions, when executed on at least one processor, causing the at least one processor to perform the method according to any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-18. (canceled)

19. A method performed by a remote user equipment (UE), comprising:
receiving, at a packet data convergence protocol (PDCP) entity of the remote UE from a first radio link control (RLC) entity of the remote UE, an indication of successful delivery of a protocol data unit (PDU), wherein the remote UE is connected to a network device via a direct path and an indirect path; and
indicating, to a second RLC entity of the remote UE, to discard the PDU in a case where the first RLC entity is not associated with a sidelink relay adaptation protocol (SRAP) entity of the remote UE, wherein the second RLC entity is associated with the SRAP entity.

20. The method of claim 19, wherein the direct path is not associated with the SRAP entity and the indirect path is associated with the SRAP entity.

21. The method of claim 19, wherein the direct path is configured with the first RLC entity, a first media access control (MAC) entity and a first physical layer (PHY) entity, and the indirect path is configured with the SRAP entity, the second RLC entity, a second MAC entity and a second PHY entity.

22. The method of claim 19, further comprising:
disabling, at the PDCP entity, indicating to the second RLC entity to discard the PDU in a case where the first RLC entity is associated with the SRAP entity.

23. A remote user equipment (UE), comprising:
a processor configured to cause the remote UE to:
receive, at a packet data convergence protocol (PDCP) entity of the remote UE from a first radio link control (RLC) entity of the remote UE, an indication of successful delivery of a protocol data unit (PDU), wherein the remote UE is connected to a network device via a direct path and an indirect path; and
indicate, to a second RLC entity of the remote UE, to discard the PDU in a case where the first RLC entity is not associated with a sidelink relay adaptation protocol (SRAP) entity of the remote UE, wherein the second RLC entity is associated with the SRAP entity.

24. The remote UE of claim 23, wherein the direct path is not associated with the SRAP entity and the indirect path is associated with the SRAP entity.

25. The remote UE of claim 23, wherein the direct path is configured with the first RLC entity, a first media access control (MAC) entity and a first physical layer (PHY) entity, and the indirect path is configured with the SRAP entity, the second RLC entity, a second MAC entity and a second PHY entity.

26. The remote UE of claim 23, wherein the remote UE is further caused to:
disable, at the PDCP entity, indicating to the second RLC entity to discard the PDU in a case where the first RLC entity is associated with the SRAP entity.
